(19) United States
(12) Patent Application Publication
(10) Pub. No.: US 2024/0112221 A1
(43) Pub. Date: Apr. 4, 2024

(54) System and Method for Mobile Geofencing

(71) Applicant: Productive Application Solutions, Inc., Sheridan, WY (US)

(72) Inventors: Peter Ta, Tucson, AZ (US); Gerald Maliszewski, San Diego, CA (US)

(21) Appl. No.: 18/538,280

(22) Filed: Dec. 13, 2023

Related U.S. Application Data
(63) Continuation-in-part of application No. 18/477,402, filed on Sep. 28, 2023.
Application No. 18/477,402 is a continuation-in-part of application No. 17/962,513, filed on Oct. 9, 2022, now Pat. No. 11,880,869.
Application No. 17/962,513 is a continuation-in-part of application No. 17/830,783, filed on Jun. 2, 2022.
Application No. 17/830,783 is a continuation-in-part of application No. 17/830,412, filed on Jun. 2, 2022.
Application No. 17/830,412 is a continuation-in-part of application No. 17/230,008, filed on Apr. 14, 2021, now Pat. No. 11,270,349.
Application No. 17/230,008 is a continuation-in-part of application No. 17/201,419, filed on Mar. 15, 2021.
Application No. 17/201,419 is a continuation-in-part of application No. 17/179,574, filed on Feb. 19, 2021, now Pat. No. 11,257,120.
Application No. 17/179,574 is a continuation-in-part of application No. 17/168,313, filed on Feb. 5, 2021.
Application No. 17/168,313 is a continuation-in-part of application No. 17/133,722, filed on Dec. 24, 2020, now Pat. No. 11,055,743.
Application No. 17/133,722 is a continuation-in-part of application No. 17/097,256, filed on Nov. 13, 2020, now Pat. No. 11,887,163.
Application No. 17/097,256 is a continuation-in-part of application No. 17/071,043, filed on Oct. 15, 2020, now Pat. No. 11,037,199.
Application No. 17/071,043 is a continuation-in-part of application No. 17/023,546, filed on Sep. 17, 2020, now Pat. No. 10,991,007.
Application No. 17/023,546 is a continuation-in-part of application No. 17/007,575, filed on Aug. 31, 2020, now Pat. No. 11,468,477.
Application No. 17/007,575 is a continuation of application No. 16/869,696, filed on May 8, 2020, now Pat. No. 10,803,488.
Application No. 16/869,696 is a continuation of application No. 16/601,362, filed on Oct. 14, 2019, now Pat. No. 10,796,340.
(60) Provisional application No. 63/431,214, filed on Dec. 8, 2022.
(60) Provisional application No. 63/310,857, filed on Feb. 16, 2022.
(60) Provisional application No. 62/779,972, filed on Dec. 14, 2018.

(51) Int. Cl. G06Q 30/0251; G06F 16/487; G06Q 30/0242

(52) U.S. Cl. CPC G06Q 30/0266; G06F 16/487; G06Q 30/0244; G06Q 30/0252; G06Q 30/0267

(57) ABSTRACT

A system and method are provided for mobile center geofencing. A geofencing node receives mobile center unit data communications including mobile center unit locations. The mobile center unit geographic location is positioned on a map, and geofence boundaries are created on the map around the mobile center unit geographic locations. In the case that the mobile center unit is a mobile media unit, capable of selectively projecting media messages, the mobile media unit geographic locations are cross-referenced to media projection information. The mobile center unit data being received may include mobile media unit geographic locations cross-referenced to time. Then, mobile media unit geographic locations may be cross-referenced to the media projection information with respect to the time. If the mobile media unit data receives media message projection selective enablement times, the media message projection enablement times are cross-referenced to mobile media unit geofence boundaries.

### RELATED APPLICATIONS

Any and all applications, if any, for which a foreign or domestic priority claim is identified in the Application Data Sheet of the present application are hereby incorporated by reference under 37 CFR 1.57.

### BACKGROUND OF THE INVENTION

### 1. Field of the Invention

This invention generally relates to public information identification services and, more particularly, to a system and method for geofencing the boundaries surrounding mobile centering units.

### 2. Description of the Related Art

Geofencing is the application of a virtual boundary around a location, in which certain rules are applied when a mobile device enters or leaves. The size of a geofence can be modified, but most often the shape is a standard radius. A polygon geofence, or boundaries that are more geometric in shape, is another form of geofencing that can more specifically outline the shapes of certain landmarks, buildings, or areas. Typically, geofencing mobile messages are be used in the form of display or push notifications to mobile device users with locally relevant messages, Most often, Global Position Satellite (GPS) data is used to define whether a mobile device has entered the geofence. GroundTruth's Blueprints, for example, is a proprietary geofencing marketing software that offers its clients the ability to more accurately harness the power of offline behavior. Blueprints allows for contextual layering for a single Point of Interest, which helps separate a particular location from a more general region.

The most basic method of location-based geofencing places a radius around an address linked to a particular location. In some instances, however, the preferred geofence center has no address, as would be the case for a parking lot for example. Otherwise, geofencing can be based around an event that gathers numerous people who are similarly interested in a topic whether it is a sporting event, corporate conference, rock concert, or renaissance festival. Knowing what events interest, and are attended by a target audience, can be utilized to advantage with Event Geofence Retargeting. Event Geofence Retargeting is a precise geo-targeting technology, allowing organizations such as Beyond Spots & Dots to target individuals who attend a specific event during a predetermined time frame and serve them messages.

Event Geofence Retargeting works as follows. A virtual geofence is drawn around an event location where a target audience is scheduled. When event attendees enter the geofenced location and check their phone to post to social media or check the weather, the geofence captures their data. The event attendees then become part of a custom audience that can be served notices, even after the event ends.

Even when the target audience is mobile, conventional geofencing requires fixed position boundaries around an event location, which in turn, requires fixed position data collection nodes. However, there are circumstances when the target event position changes or becomes non-predetermined. In this situation the target audience migrates away from a predetermined fixed position boundary, and geofencing data is lost.

It would be advantageous if the geofencing data collection nodes could be made mobile.

It would be advantageous if mobile geofencing data collection nodes could help create mobile (moveable) geofencing boundaries.

It would be advantageous if geofencing could be maintained around a center of interest while the center is in non-predetermined motion.

In addition, it would be advantageous if the location of mobile geofence center of interest could be accurately tracked in real-time.

### SUMMARY OF THE INVENTION

A system and method are disclosed herein permitting the creation of mobile geofencing boundaries. Typically, the term “mobile”, “mobile device”, or “mobile unit” when used in the context of geofencing refers to client devices that may enter (or exit) a geofenced area. Sometimes these mobile client devices are the recipients of public notifications as a result of being located within a geofence. Otherwise, it may be of interest that mobile device users may have been exposed to a particular message by determining their presence inside a geofenced area. However, as used herein, the term “mobile” also refers to a moving geofence center. The system and method described herein track the location of a mobile geofence center unit, which may be a mobile media distribution node, so that it can be entered on a map. A geofence boundary is created around the mobile geofence center unit, and if the geofence center unit is moving, the geofence boundaries are likewise moving. Then, conventional means can be used to determine client devices (e.g., smartphones) located within the (moving) geofence and, optionally, the mobile center may aid in the capture client device data.

Accordingly, a method for mobile center geofencing is provided. A geofencing node receives mobile center unit data communications including mobile center unit locations and, optionally, information regarding any media (public service or emergency broadcast messages) it may be projecting. For example, the geofencing node can be a server maintaining a wireless communications link with one or more mobile center units. The mobile center unit geographic location is positioned on a map, and geofence boundaries are created on the map around the mobile center unit geographic locations. In the case that the mobile center unit is a mobile media unit, capable of selectively projecting media messages, the mobile media unit geographic locations are cross-referenced to media projection information. The mobile center unit data (i.e., mobile media unit data) being received may include mobile media unit geographic locations cross-referenced to time. Then, mobile media unit geographic locations may be cross-referenced to the media projection information with respect to the time. More explicitly, the mobile media unit data being received may be selectively enabled and include media message projection times, and the media message projection times are cross-referenced to mobile media unit geofence boundaries. If the mobile media units are capable of projecting a plurality of messages, then receiving the mobile media unit data may include receiving the identification of a projected message, selected from the plurality of messages, cross-referenced to time. Then, the mobile media unit geographic locations are cross-reference the projection time of the identified messages to mobile media unit geofence boundaries. The mobile center unit data may also include mobile center (media) unit geographic locations cross-referenced to durations of time the mobile center (media) units are stationary.

In one aspect, receiving the mobile center unit data may include receiving the mobile center (media) unit type. Some examples of mobile center (media) types may include cars, trucks, motorcycles, mobile sandwich boards, and aerial drones. Then, the geofence boundaries may be created for a mobile center (media) unit based upon mobile media type. For example, the boundaries for an aerial drone may be relatively large based upon the assumption that it is easier to see, or the boundaries for a car located in heavy traffic may be relatively small based upon the assumption that it is more difficult to see. Alternatively, or in addition, geofence boundaries for a mobile center (media) unit may be created based upon mobile center (media) unit local environment or view analysis. For example, geofence boundaries in a downtown area may be made relatively small based upon the assumption that a concentration of buildings occludes viewing from a distance. The geofence boundaries may also be adjusted based upon weather conditions or time of day.

In one aspect, the geofencing node may receive client device geographic location information cross-referencing client devices to client device geographic locations. The client devices may be recognized based, for example, on conventional geofencing techniques that capture client Internet Protocol (IP) addresses (e.g., GroundTruth's Blueprints). In this case the client device geographic locations can be positioned on the map and the client device geographic locations are cross-referenced to mobile center (media) unit geofence boundaries. Further, the client device information may include geographic locations cross-referenced to time, so that client device geographic locations can be cross-referenced to mobile center (media) unit geofence boundaries with respect to the time. In this manner an analysis can be performed based upon the probability of a client device user located within the geofenced boundary seeing mobile center (media) unit image projections. In some instances, the client device information may be collected and relayed by a communicating mobile center (media) unit.

Additional details of the above-described method, and systems for mobile center geofencing, are provided below.

### BRIEF DESCRIPTION OF THE DRAWINGS

FIG. 1A is a schematic block diagram of a system for mobile center geofencing, and FIGS. 1B through 1F are drawings representing geofence maps.

FIG. 2A is a schematic block diagram of an alternative system for mobile media geofencing, and FIGS. 2B through 2D are drawings representing geofence maps.

FIG. 3 is a flowchart illustrating a method for mobile center geofencing.

FIG. 4 is a flowchart illustrating a method for mobile media geofencing.

FIG. 5 is a drawing depicting an exemplary mobile center unit.

FIG. 6 is a schematic block diagram of an aerial system for mobile center geofencing.

### DETAILED DESCRIPTION

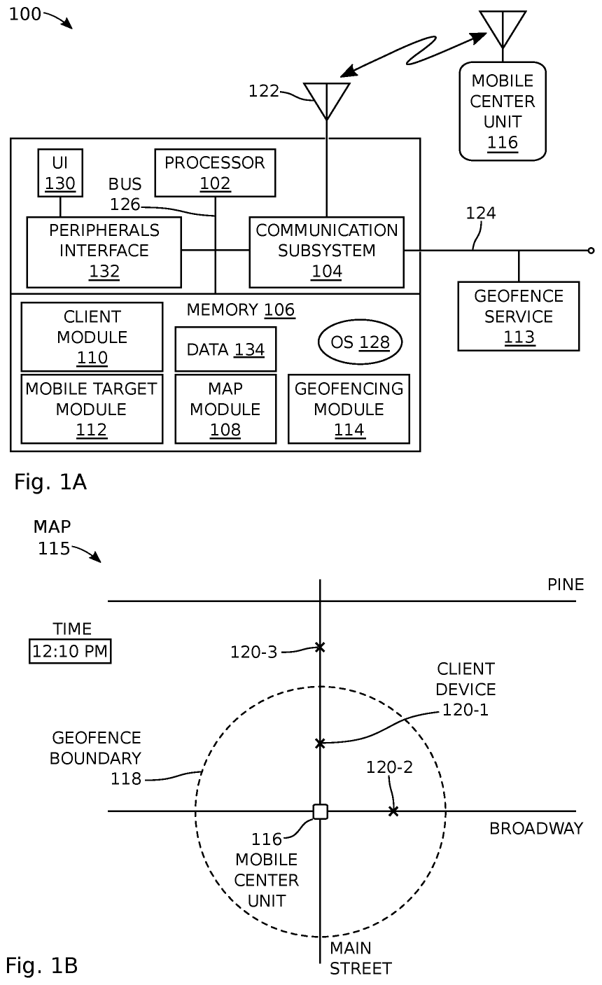

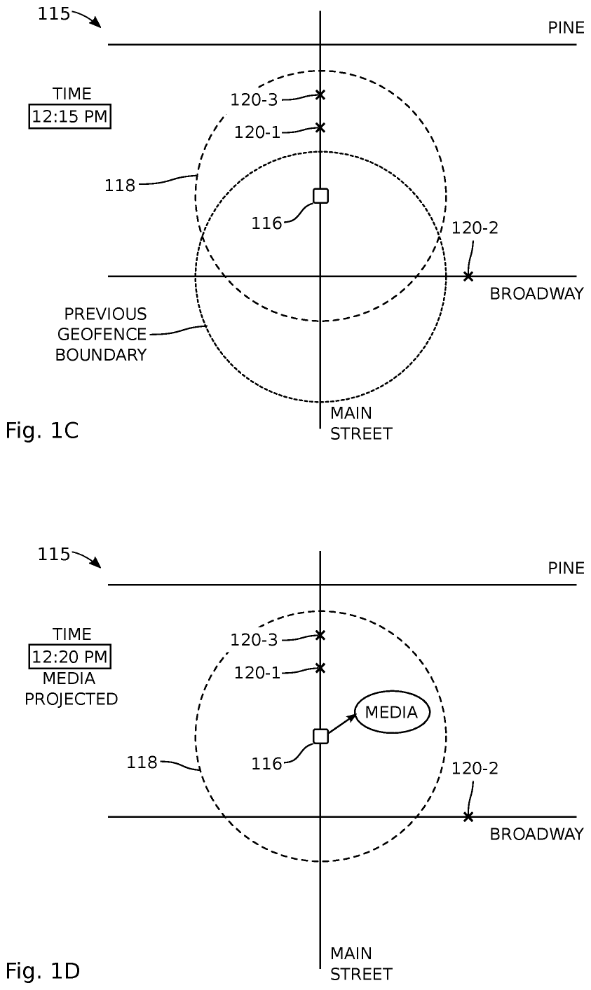

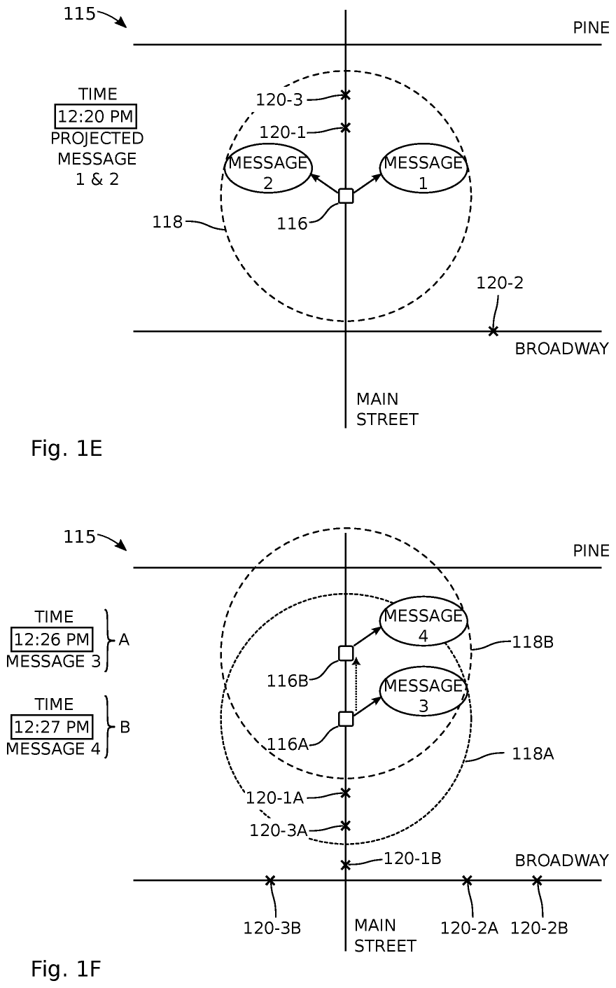

FIG. 1A is a schematic block diagram of a system for mobile center geofencing, and FIGS. 1B through 1F represent geofence maps. A communications subsystem 104 receives client data, as well as mobile media data from a mobile center unit 116. A map module 108 comprises a map of static feature or predetermined (e.g., known) geographic locations. A client module 110 accepts client data including geographic location information for client devices. A mobile target module 112 accepts mobile center data including geographic location information for the mobile center unit 116. In one aspect, the client data is collected by the mobile center unit 116 and transmitted wirelessly via communications subsystem 104 first interface. For example, the mobile center unit 116 may offer WiFi, Bluetooth, or Internet services to a client device that permits the mobile center unit to acquire the client device's Internet Protocol (IP) information. Otherwise, the mobile center unit 116 may be able to collect the IP addresses of client devices searching for wireless service. Alternatively, a geofence data collection service 113, such as GroundTruth's Blueprints, may collect client data using sources external to the system 100, which is transmitted via a communications subsystem 124 second interface, using an Ethernet or Internet protocol for example. A geofencing module 114 positions the client device geographic locations on the map, positions the mobile center unit geographic locations on the map, creates geofence boundaries on the map around the mobile center unit geographic locations, and cross-references client device geographic locations to mobile center unit geofence boundaries.

The system 100 is enabled with a processor 102 and a non-transitory memory 106. The memory 106 comprises processor executable instructions. Modules 108, 110, 112, and 114 have been presented in this example so as to demonstrate how the invention can be enabled using software, and it should be understood the modules are in communication with each other and may, alternatively, be represented as a single software application, as software modules distributed across multiple computing systems, or partially enabled with hardware.

In FIG. 1B a map 115 is shown with the static features of roadways. Alternative static features might include addresses, public landmarks, geological features, latitude/longitude coordinates. Alternatively, location can be referenced with respect to other mobile center locations. A mobile center unit 116 is shown located at the intersection of Main and Broadway and a geofence boundary 118 is shown surrounding mobile center unit 116. The area inside the boundary is considered to be geofenced. The boundary 118 is depicted as circular circumference, but the boundary is not limited to any particular shape. Client devices 120-1 and 120-2 are located within the boundary 118, and client device 120-3 is located outside the boundary. The client data and mobile center data may be cross-referenced to time, in which case the client device geographic locations are cross-referenced to mobile center unit geofence boundaries with respect to the time. The locations on the map 116 are referenced to a time of 12:10 PM.

FIG. 1C depicts locations of the map at time 12:15. It should be noted that the mobile center unit 116 has moved in that time interval, and so the geofence boundary 118 has moved in a corresponding manner. The pervious geofence boundary (at time 12:10 PM) is shown in phantom. Although not shown in the interest of simplicity, the timing information might also include date, month, time zone, and year.

The system 100 depicted in FIG. 1A may be used for the purpose of geofencing client devices. As noted above, geofencing is the application of a virtual boundary around a location, in which certain rules are applied when a mobile device enters or leaves. The size of a geofence can be modified, but most often the shape is a standard radius. A polygon geofence, or boundaries that are more geometric in shape, is another form of geofencing that can more specifically outline the shapes of certain landmarks, buildings, or areas. The shape of the geofence may also be responsive to the speed and/or direction in which a mobile center unit is moving, or the type of mobile center unit. A Global Positioning Satellite (GPS) system or other form of location system is typically used to define mobile center unit and client device positions, whether a client device has entered or exited the geofence.

The most basic method of location-based geofencing is by placing a radius around the address of a static location. Events that gather numerous people together who are similarly interested in a topic, whether it be a sporting event, corporate conference, rock concert, or renaissance festival, can also be made a geofencing radius center. For example, a virtual geofence can be drawn around an event location where a target audience event is scheduled. When event attendees enter the geofenced location and check their phone to post to social media or check the weather, the client module captures their data. The event attendees then become part of a custom audience that can be served public service notifications during the event, and even after the event when the attendees exit the geofence. One problem associated with geofencing occurs when center radius moves. That is, a problem exists when the geofence center is not a stationary or known location but is, rather, an event or a mobile center unit moving in a non-predetermined or unpredictable manner.

Conventional geofencing services, such as provided by Radar Labs, Inc., use GPS, Global Navigation System (GNSS), radio frequency identification (RFID), WiFi, cellular data, and Internet Protocol (IP) address ranges, to build virtual fences in geographic regions. These virtual fences can be used to track the physical location of a client device (e.g., smartphone) active in the particular region or the fence area. The location of the client device is taken as geocoding data and can be used to construct a picture of Internet Protocol (IP) traffic in an area.

As noted above, one problem with conventional geofencing services is that they base the center of a geofence around a static location. More explicitly, the sensors used to capture the location and IP addresses of client devices are typically based in a stationary location. However, in some applications the center of interest moves, and may move in a non-predetermined manner. In this case, conventional geofencing systems are unable to track a moving geofence center. That is, conventional geofencing systems are unable to create moving geofences. The creation of moving geofences requires the cooperation of the mobile center unit, or a separate unit, such as a camera or other mobile center unit tracking the mobile center unit location.

While in some cases the geofence center simply acts as a center for anchoring a geofence boundary for the collection of client data, in other aspects the geofence center performs additional functions. As described herein a geofence center may be enabled to help in the collection of data concerning the projection of public service media. The projection of media, coupled with non-predetermined movement, complicates the task of geofencing. If the mobile center units comprise a media projection subsystem to selectively project public service or emergency broadcast media messages, the mobile center data may include media message projection times. In this case, the geofencing module cross-references client devices located with the geofence boundaries to media message projection times.

FIG. 1D represented the projection of a message at time 12:20 and the locations of client units 120-1, 120-2, and 120-3 at the time of projection. In some cases the mobile center units may be capable of projecting a plurality of messages in parallel (simultaneously) and/or in series. Then, the mobile center data includes the identification of a projected message(s), selected from a plurality of messages, cross-referenced to time. The geofencing module cross-references client devices located with the geofence boundaries to the projection times of the identified messages.

FIG. 1E depicts the simultaneous projection of messages 1 and 2 at 12:25, and in FIG. 1F the serial projection of messages 3 and 4, respectively, at times 12:26 (time A) and 12:27 (time B). In some aspects, the mobile center data includes mobile center unit geographic locations cross-referenced to durations of time the mobile center units are stationary, and stationary duration information can be added to the map. For example, mobile center unit 116 may be stationary from time 12:20 until 12:25.

The mobile center data may include the mobile center unit type. For example, mobile center unit types include cars, trucks, boats, portable kiosks, and aerial drones to name a few examples. The mobile center unit may even be attached to a carrier animal. The geofencing module may create geofence boundaries for a mobile center unit based upon mobile center unit type. For example, an aerial drone may have a larger geofence boundary based upon the assumption that its altitude may enable it to capture client data from a greater distance away. In the case of the aerial drone being equipped with a media projection subsystem, the boundary may be larger based upon the assumption that the projection of messages by the drone may easier to see. Further, the geofence boundaries may be may smaller for low profile vehicles acting as the mobile center unit. Similarly, if the mobile center units are configured to be selectively project media messages, the geofencing module may create geofence boundaries for a mobile center unit based upon local environment. The environment may impact media view analysis. Media view analysis may be based upon assumptions reflective of visibility, time of day, day of week, weather, crowd density, or other population characteristics. As noted above, in the case of the aerial drone being equipped with a media projection subsystem, the boundary may be larger based upon the assumption that the drone is easier to see. Alternatively, the geofence boundary may be made smaller based upon local geological or urban environment features, or weather. In some aspects the mobile center units are equipped with environmental sensors, which can be used to determine a local environment, and in turn, help determine view analysis.

Returning to FIG. 1A the communications subsystem 104 may be wireless as shown connected to antenna 122 and/or via a hardline (e.g., Ethernet) connection on line 124. As in a conventional computer system, the communications subsystem 104 is operatively connected to a bus line 126, which also operatively connects to the processor 102 and memory 106. The system includes an operating system (OS) 128 embedded in memory 106. Optionally, the system may further comprise a user interface 130 and peripherals interface 132. In one aspect both the mobile center data and client data are received via the wireless interface (antenna 122), as might be the case when the mobile center unit collects and transmits client geofencing data, which data can then be stored in data file 134. In another aspect, the mobile center data may be received via the wireless interface 122 and the client data is received via the hardline (e.g., Ethernet) interface 124, such as might be the case if client data is collected using conventional means or from sources independent of the mobile center unit. In one aspect, client data may be collected by both the mobile center unit, as well as by more conventional means.

The mobile center units may be enabled as a kiosk, automotive vehicles, boats, and aerial drones, as provided in parent applications: U.S. Pat. Nos. 10,796,340, 10,803,488, 10,991,007, 11,037,199, 11,138,634, 11,055,743, Ser. No. 17/316,156, U.S. Pat. Nos. 11,138,635, 11,138,636, Ser. No. 17/097,256, U.S. Pat. Nos. 11,278,900, 11,257,120, Ser. No. 17/168,313, U.S. Pat. No. 11,270,349, Ser. Nos. 17/687,031, 17/830,412, 17/830,783, 17/962,513, and U.S. Pat. No. 11,741,500, which are incorporated herein by reference.

Sensors on the mobile center units may be used to collect local environment data, as described in parent application Ser. No. 17/983,545 for example, which can be stored in memory as data or reported back to the local arbitrator. Some examples of environmental sensor include a camera, microphone, weather sensor, odor sensor, photodetector, chemical sensor, a wireless spectrum receiver, a wireless service traffic analyzer, radiation sensor, and air quality monitor.

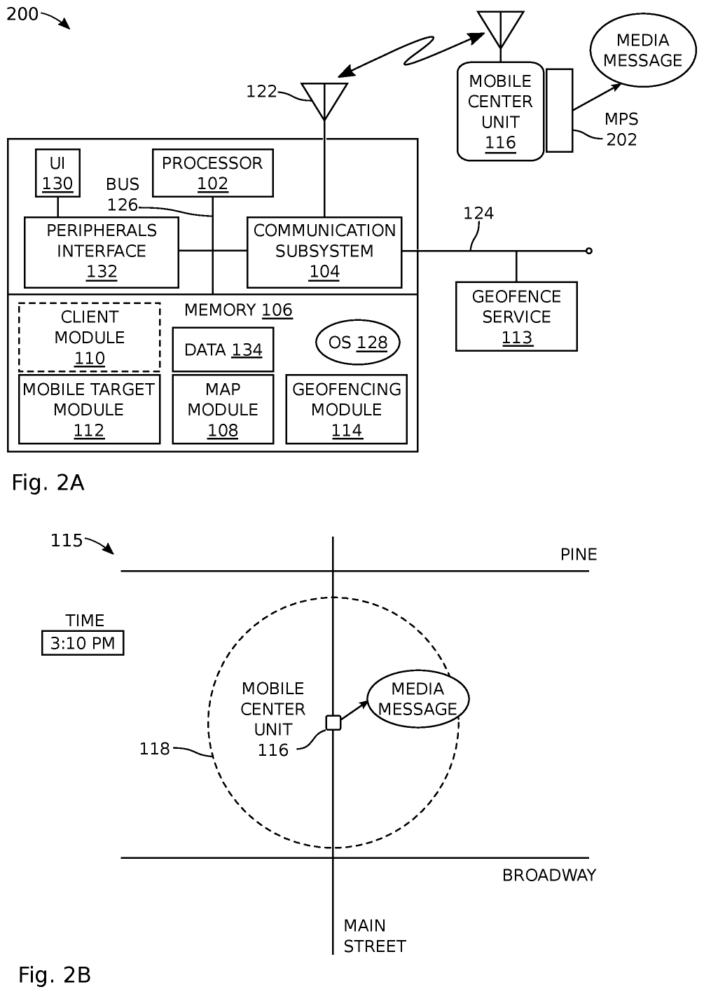

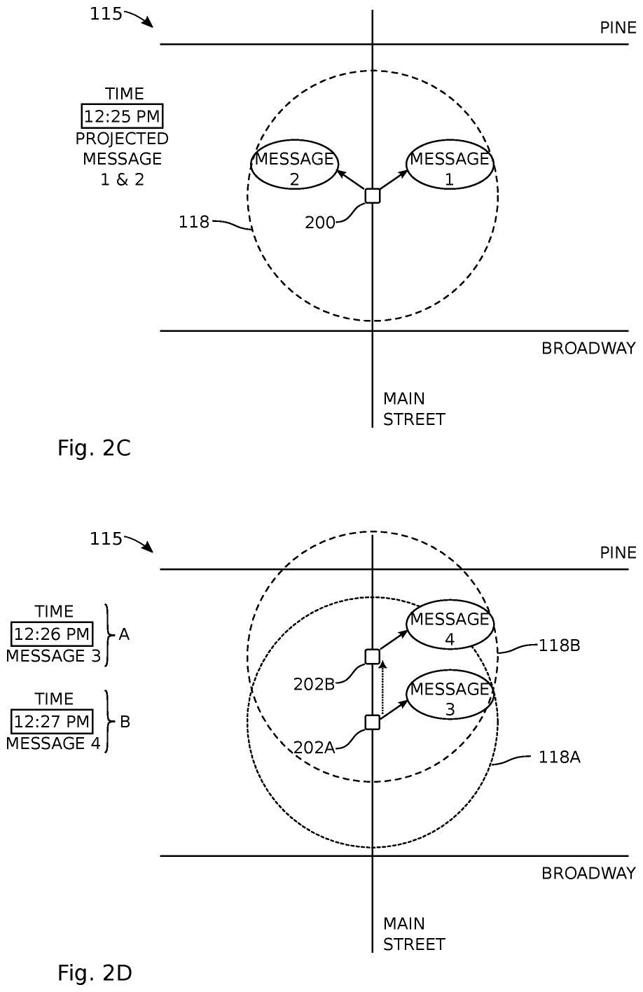

FIG. 2A is a schematic block diagram of an alternative system for mobile media geofencing, and FIGS. 2B through 2D are drawings representing geofence maps. In this aspect of system 200 the mobile center unit 116 further comprises a media projection subsystem (MPS) 202 for the presentation of public service or emergency broadcast messages, and can also be referred to as a mobile media unit. The system 200 comprises a communications subsystem 104 having an interface to accept mobile center data including mobile unit geographic location and mobile unit media message projection information. The system 200 also comprises a map module 108 comprising a map of static feature geographic locations. A mobile target module 112 accepts mobile media data including geographic location information for mobile media units. A geofencing module 114 positions the mobile media units on the map, creates geofence boundaries on the map around the mobile media unit geographic locations, and cross-references the geofence boundaries to media projection information.

The system 200 may comprise a processor 102 and a non-tangible memory 106. The memory 106 comprises processor executable instructions enabling the map module 108, mobile target module 112, and geofencing module 114. The system shown in FIG. 2A is similar to the system depicted in FIG. 1A except that the mobile center unit 116, being equipped with MPS 202, becomes a mobile media unit selectively projecting media messages 204. The client module 110 (shown in phantom) is optional, as explained in more detail below.

As shown in FIG. 2B, the mobile media data includes a mobile media unit 202 geographic location cross-referenced to time, and the geofencing module cross-references mobile center unit geofence boundaries 118 to media projection information with respect to the time. For example, media message information associated with a time of 3:10 PM is shown cross-referenced to the mobile media unit geofence boundary 118. In one aspect, the media message information is the time that a media message was actually enabled (projected). In one aspect, the mobile media center includes the identification of a projected message, selected from a plurality of messages, cross-referenced to time. Then, the geofencing module cross-references the projected times of the identified messages to mobile media unit geofence boundaries (see FIGS. 2C and 2D). The mobile center data may also include mobile center unit geographic locations cross-referenced to durations of time the mobile center units are stationary, and stationary duration information can be added to the map 115.

As explained above the geofence boundaries may also be created based upon considerations of mobile media (center) unit type and/or local environment (e.g., mobile center view analysis).

The system may optionally accept client device including client geographic location information cross-referenced to client device geographic locations. In this case the system further comprises the client module 110 for accepting client data including geographic location information for client devices, and positioning client devices on the map. Then, the geofencing module cross-references client device geographic locations to mobile media unit geofence boundaries. If the client device data includes client device geographic locations cross-referenced to time, the geofencing module cross-references client device geographic locations to mobile media unit geofence boundaries with respect to the time. As noted above, the client data may be collected by the mobile media unit and supplied via interface 122 and/or supplied by resources from outside the system 113, e.g., on line 124.

Some locations may be weighted to have a greater value than other locations. For example, locations that have greater foot traffic or greater visibility may have more value. Further, mobile center or mobile media units may have a value weighted on if they are stationary, the duration of time they are stationary, and their ability to report their stationary status. In the case of an airborne vehicle, “parking” may be understood to be maintaining an approximate location in midair, as well as a landing location. In the case of air or nautical media nodes, the launching site, landing site, or midair position may be the stationary or parking location. Examples of other weighting factors include time of day, day or week, population density or other population characteristics, or local special events to name a few.

A “stationary location” may be a parking location. “Parking” is typically understood to be location where a vehicle media node is temporarily left with its engine off, or if not self-powered, left without means of movement. Vehicles mobile center or media units may be “parked” along city streets, on sidewalks, in stores and publically accessible buildings or in publicly accessible areas, such as parking lots. Mobile center or media units are typically “parked” for limited durations of time, typically a matter of hours, but the durations can be as small as minutes or larger than even weeks. “Temporary” is understood to typically be a duration of several minutes to several hours, although it may also be a matter of days or even weeks. “Occupation” is understood to mean filling a space or location so completely that another vehicle or entity is unable to fill that space. In the case of drone aircraft or boat mobile unit, these vehicles may need to be powered with engines running to maintain a stationary location. The weighted values can be established, at least partially, using conventional geofencing services, such as provided by Radar Labs, Inc.

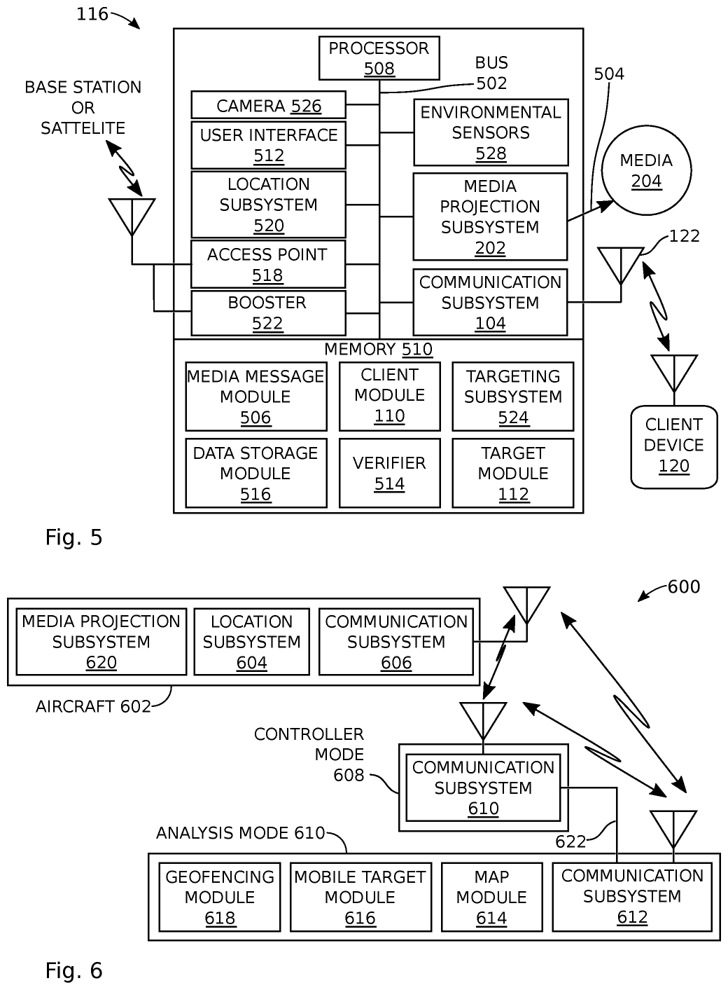

FIG. 5 is a drawing depicting an exemplary mobile center unit or mobile media unit. The mobile center unit 116 described below may provide a number of functions and services. It should be understood that the mobile center unit need not incorporate all the services described below. In one aspect, the mobile center unit may comprise a media projection subsystem 202, which may be selectively engaged in cooperation with the media messaging subsystem that may supply an enablement signal (enablement acknowledgement) on bus line 502 when enabled. The media projection subsystem 500 has an interface, represented by reference designator 504, to project a form of media 204. A media message system 506 may supply media message enablement signals, for a selected media message, to the mobile center unit 202. In one aspect, the media message system 506 transmits a selected media message to the media center unit. In this case, the media center unit 116 may be equipped with a processor 508 and local memory 510 to store the received massage. The media projection subsystem 202 may be a display device, such as a light emitting diode (LED) or liquid crystal (LC) display that is able to project still images or video messages stored in local memory.

The mobile media unit media projection subsystem (MPS) 202 may be a LED or LC display, a sidewalk or wallscape image projector, a retractable screen, a topper, holographic display, electroluminescent (EL) display, switchable glass displays, persistent image fan, or combinations thereof. An image projector may be enabled as a LC or LED display similar to a home theater type video projector. Alternatively, high performance (e.g., mercury arc or xenon arc) lamps, cathode ray tube (CRT), digital light processing (DLP), plasma, silicon X-tal reflective display (SXRD), or red-green-blue (RGB) lasers may be used. In other words, the MPS may present a 2-dimensional or 3-dimensional image, which may or may not be transitory. Transitory images include a series of still images, videos, or combinations thereof. The media center unit may also broadcast audio messages, or a combination for audio and visual messages.

The mobile center unit 116 may further comprise a user interface (UI) 512 and a publically accessible access point (AP) 518, such as an IEEE 802.11 Wireless Local Area Network (WLAN) AP, an IEEE 802.15 Wireless Personal Area Network (WPAN) AP, and combinations thereof. In this case the communications subsystem may enable AP data traffic via a communications subsystem 104 cellular network. Alternatively, the AP may act as the communications subsystem, especially if the relaying devices are located nearby. Less common, the access point may an IEEE 802.15.4 Zigbee, WPAN IEEE 802.15 Li-Fi or wireless USB device. Even more unlikely as an access point are Long Range Wireless systems. As used herein, a “publically accessible” is a system that can be accessed by the general public without a password or similar security measures, or where the password is publically distributed. One example of a publically accessible AP is the WiFi hotspot service provided by a typical Starbucks coffee shop. In the case of a password being required for access, the password may be printed on the mobile platform, displayed by the media projection subsystem, or made available through a media projection phone application or website.

To track their locations, the mobile center or mobile media units typically rely upon an embedded location subsystem 520, such as a GPS system receiver, GNSS, assisted GPS or GNSS taking advantage of cell tower data, a Wireless Local Area Network IEEE 802.11 (WiFi) positioning system, cell-site multilateration (e.g., Skyhook), satellite multilateration, or a hybrid positioning system. Hybrid positioning systems find locations using several different positioning technologies, such as GPS, combined with cell tower signals, wireless internet signals, Bluetooth sensors, IP addresses, and network environment data. Cell tower signals have the advantage of not being hindered by buildings or bad weather, but usually provide less precise positioning. WiFi positioning systems may give very exact positioning in urban areas with high WiFi density, depending on a comprehensive database of WiFi access points. Further, a LORAN type system or LoJack® type system might be adapted for the purpose of location determination. As noted in U.S. Pat. No. 10,796,340, which is incorporated herein by reference, camera images and the location data of proximate smartphones, laptops, and personal communication devices can also be used to determine location.

The most typical examples of the communications subsystem 104 are wireless cellular systems (e.g., Global System for Mobile Communications (GSM), Universal Mobile Telecommunications System (UMTS)-time division duplexing (TDD), Long-Term Evolution (LTE), 4^{th} Generation (4G), or 5^{th} Generation (5G)), and the like. Less typically, the communications subsystems may be enabled with WLAN IEEE 802.11 (WiFi), or even Long Range Wireless transceiver. Some examples of a Long Range Wireless system include Digital Enhanced Cordless Telecommunications (DECT), Evolution-data Optimized (EVDO), General Packet Radio Service (GPRS), High Speed Packet Access (HSPA), IEEE 802.20 (iBurst), Multichannel Multipoint Distribution Service (MMDS), Muni WiFi, commercial satellite, and IEEE 802.16 Worldwide Interoperability for Microwave Access (WiMAX (WiBro)). The system is not limited to any particular type of communication subsystem and it should be understood that a typical cellular link includes intervening base station and hardline connections.

The access point and/or communications subsystem can be used to collect client data from entities passing by, or engaging with the access point or using the communications subsystem. This data can be stored in local memory data storage module 516 for subsequent recovery or transmission to the client module 110 in support of data gathering or geofencing data. In support of data mapping, the access point is publically accessible to client devices that include smartphones, personal devices, or generally any type of computing device. Typically, the client (user) devices 120 are enabled for WiFi and Bluetooth communications. If left enabled, as is the typical case for many users, the client device is able to interact with a nearby access point even if a communication data link is not established. As used herein, the term data mapping includes the collection of data from the user devices. In one aspect, user data information (e.g., addresses) is collected voluntarily, with the user explicitly agreeing to data collection in response to an access point provided services, such as the provision of an Internet browser, email, Internet, social media services, or smartphone applications.

Optionally, the mobile center unit 116 may further comprise a verifier, or verification subsystem 514. Here, the verifier 514 is enabled as a software application stored in local non-transitory memory 510, including processor executable instructions to receive location directions, media enablement signals, an identification code, and the geographic location, to supply verification information responsive to the direction and media enablement acknowledgements, the identification code, the geographic location. The determination of location may involve determining if the mobile center unit is stationary or in motion, or durations of time the mobile center unit is stationary or in motion. Alternatively, at least some components of the verifier 514 may be enabled in hardware.

The communications subsystem may include a signal booster 522, such as a device provided by WeBoost, or a similarly functioning proprietary device. The booster may act as a relay between a proximately located client device 120 and a cellular network (i.e., base station or satellite). In other aspects, a signal booster 522 acts to relay Internet signals, such as might be useful when employed with the StarLink or similar Internet service, as the StarLink ground units require an uninterrupted view of the sky (i.e., view of the StarLink satellites) For example, the mobile center (media) unit may be positioned in areas of weak cellular coverage. Using the site selection and targeting components mentioned above, mobile center (media) units can be directed to, and rewarded for established cellular boosters in poor coverage areas. Improved cellular coverage necessary improves Internet and WiFi services carried by the cellular service.

In the case of a mobile center unit independently selecting its location, the mobile center unit 116 may incorporate a targeting subsystem 524 to support the selection of stationary locations, which may have corresponding location values. As shown, the targeting subsystem 524 is enabled as software application stored in local memory 510. In some variations the targeting subsystem may be enabled with hardware. The listed stationary locations may be associated with rewards provided to an entity. The entities involved may include the entity managing the system of, the user making the location selections, the entity managing the mobile unit, an entity owning the property upon which the mobile unit is located, or combinations of the above-mentioned entities.

As used herein, an “entity” may be a person, a business, a corporation, government organization, any type of social organization or business unit, a physical device, or a software application. For simplicity, the entities may be identified as the hardware components being used by, or associated with a business, person, corporation, government organization, or social organization. In this case, the entity may be described as a computer, smartphone, media projection subsystem, server, or vehicle, to name a few examples.

The mobile center unit 116 may include a camera 526 to record images of the geographic location proximate to the media unit. The camera images may be stored in the data storage module 516 in local memory 510, or the communications subsystem 104 may transmit the images. In one aspect, the camera may also be used to modify the value of the target location. For example, the recorded traffic in a location may be greater than anticipated, and the weighted value or view analysis adjusted accordingly. That is, images recording higher pedestrian or vehicular traffic may indicate, at least temporarily, a greater location value. The data may be used to help determine the efficacy of the media or location. Alternatively or in addition, the camera images my act to verify that the media projector subsystem 202 has been enabled, media center (media) unit movement, or lack thereof, or identification of a particular location. In one aspect, simply recording a change in images, and thus proximate traffic, can be used as a means for proving media projector subsystem enablement. As an alternative, or in addition to the camera, the system may further comprise environmental sensors 528, such as a microphone, weather sensor, odor sensor, photodetector, chemical sensor, a wireless spectrum receiver, a wireless service traffic analyzer, radiation sensor, air quality monitor, or a proximity detector subsystem to sense nearby motion, or to measure the density of proximate vehicular or foot traffic, which data is transmitted by the communications subsystem or recorded in local memory.

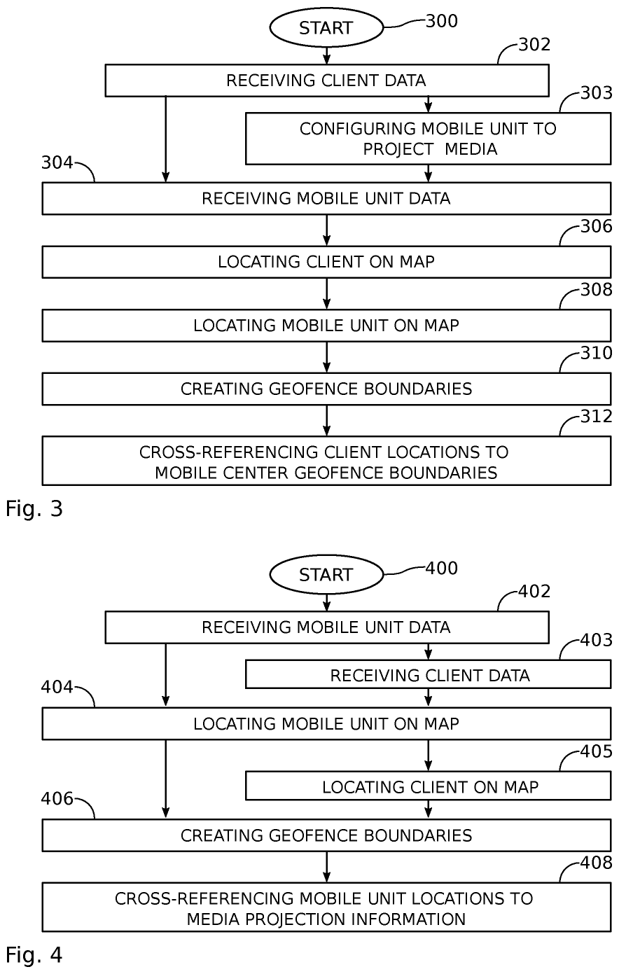

FIG. 3 is a flowchart illustrating a method for mobile center geofencing. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method steps are supported by the above system descriptions and, generally, the method generally follows the numeric order of the depicted steps. The method starts at Step 300.

In Step 302 client device data communications are received. As noted above, client data may be collected by a mobile center unit, independent geofencing service, or a combination of the two. In Step 304 mobile center data communications are received. Client device data and mobile center data have been described in detail above. In Step 306 a geofencing node locates client device geographic locations on a map. Step 308 locates mobile center unit geographic locations on the map. Step 310 creates geofence boundaries on the map around the mobile center unit geographic locations. Step 312 cross-references client device geographic locations to the mobile center unit geofence boundaries. In one aspect, receiving client device data communications in Step 302 includes receiving client device geographic locations cross-referenced to time, and receiving mobile center data communications in Step 304 includes receiving mobile center unit geographic locations cross-referenced to time. Then, cross-referencing client device geographic locations to the mobile center unit geofence boundaries in Step 312 includes cross-referencing client device geographic locations to mobile center unit geofence boundaries with respect to the time.

In another aspect, receiving mobile center unit data in Step 304 includes receiving mobile center unit type, and creating geofence boundaries on the map around the mobile center unit geographic locations in Step 312 includes creating geofence boundaries for a mobile center unit based upon mobile center unit type.

In one aspect, in Step 303 mobile center units configured as mobile media units selectively project media messages, and Step 312 creates geofence boundaries for a mobile media unit based upon mobile media view analysis. Further, receiving mobile center data in Step 304 may include receiving media message projection enablement times, and Step 312 cross-references client devices located within the geofence boundaries to media message projection enablement times. If the mobile media units are capable of projecting different messages at the same time or in series, then Step 304 may receive mobile center data with the identification of projected messages, selected from a plurality of messages, cross-referenced to time. Step 312 then cross-references client devices located with the geofence boundaries to the projected times of the identified messages. In some aspects client devices outside the geofence boundary may also be mapped, especially if they were previously within the boundary or if they appear likely to enter the boundary. In one variation Step 304 receives mobile media unit geographic locations cross-referenced to durations of time the mobile media units are stationary, and in Step 312 this information can be added to the geofencing map.

FIG. 4 is a flowchart illustrating a method for mobile media geofencing. The method begins at Step 400. In Step 402 a geofencing node receives mobile center unit data communications from an MPS-equipped mobile center unit, which may be referred to as a mobile media unit, including mobile center (media) unit locations and media projection information. Step 404 locates mobile center unit geographic locations on a map. Step 406 creates geofence boundaries on the map around the mobile center unit geographic locations. Step 408 cross-references mobile center unit geographic locations to media projection information. Typically, Step 402 receives mobile center unit geographic locations cross-referenced to time, and Step 408 cross-references mobile center unit geographic locations to media projection information with respect to the time. In one aspect the mobile media units are configured to selectively project media messages, in which case Step 402 may receive media message projection times and Step 408 may cross-reference the media message projection enablement times to mobile center unit geofence boundaries. If the mobile center units are capable of projecting several messages in parallel and/or in series, Step 402 may receive the identification of projected messages, selected from a plurality of messages, cross-referenced to time. Then, cross-referencing mobile center unit geographic locations to media projection information in Step 408 includes cross-referencing the projected times of the identified messages to mobile center unit geofence boundaries. Step 402 may also receive mobile center unit geographic locations cross-referenced to durations of time the mobile center units are stationary, in which case Step 408 may also add mobile center unit stationary locations to the map.

In one variation Step 402 receives the mobile center unit type and Step 408 creates geofence boundaries for a mobile center unit based upon mobile center unit type. Step 408 may also adjust geofence boundaries for a mobile center unit based upon mobile media view analysis.

In one aspect, Step 403 includes receiving client device geographic location information cross-referencing client devices to client device geographic locations. Step 406 locates the client device geographic locations on the map, and Step 408 cross-references client device geographic locations to mobile center unit geofence boundaries. As with the mobile center unit data, Step 403 may receive client device geographic locations cross-referenced to time, and Step 408 cross-references client device geographic locations to mobile center unit geofence boundaries with respect to the time.

FIG. 6 is a schematic block diagram of an aerial system for mobile center geofencing. The system 600 comprises an aircraft 602. The aircraft 602 comprises a location subsystem 604 to determine aircraft location. A communication subsystem 606 receives instructions and transmits location information. The system 600 also comprises a controller node 608. The controller node 608 comprises a communications subsystem 610 to send instructions to the aircraft 602, receive location information from the aircraft, and to relay the aircraft location information to an analysis node 610.

The analysis node 610 comprises a communications subsystem 612, for receiving the relayed aircraft location information, and a map module 614. The map module 614 comprises a map of geographic locations. A mobile target module 616 accepts aircraft geographic location information and positions the aircraft 602 on the map. A geofencing module 618 creates geofence boundaries on the map around the aircraft geographic location.

In one aspect the aircraft 602 further comprises a media projection subsystem 620. In another aspect, the analysis node communications subsystem 612 accepts client device geographic location information and the geofencing module 618 cross-references client device geographic locations to the geofence boundaries.

The controller node communications subsystem 610 may communicate with the analysis node communications subsystem 612 via link 622, which can be a hardwired (e.g., Ethernet) or wireless interface. In some aspects, the analysis node may accept aircraft location information directly (wirelessly) from the aircraft 602, as shown with wireless interface 624. Although not shown in detail, components of the aircraft, controller node, and analysis node may be enabled in a manner similar to that shown in FIGS. 1A, 2A, and 5.

In one aspect a relationship may exist between the controller and analysis nodes, where the analysis node supplies explicit time and location instructions to the controller node, which become instructions to the aircraft. Communications from the aircraft indirectly through the controller node, or directly to the analysis node, act to verify that the instructions are being followed. In other aspects, the analysis node may supply general instructions. For example, the general instructions may request that the aircraft operate over neighborhood S, and then communications from the aircraft indirectly through the controller node, or directly to the analysis node, act to verify how the instructions are being followed. For example, the verification communications may indicate that the aircraft operated over a particular traffic intersection in neighborhood S at 2 PM. In another aspect, the analysis node does not supply any instructions (e.g., time and place) to the controller node or aircraft, and the analysis mode has no apriori knowledge of when or where the aircraft will be operating. Again, communications from the aircraft indirectly through the controller node, or directly to the analysis node, act to supply timing, position, media presentation, or sensor (e.g., environmental) data. In this case the analysis node may be a geofencing service. The geofencing service may supply some data for the controller node if the controller node comprises a geofencing module.

Systems and methods have been provided for geofencing mobile boundary centers. Examples of particular message structures, schematic block linkages, and hardware units have been presented to illustrate the invention. However, the invention is not limited to merely these examples. Other variations and embodiments of the invention will occur to those skilled in the art.

We claim:

1. A system for mobile center geofencing, the system comprising:
a communications subsystem for receiving client data and mobile media data;
a map module comprising a map of predetermined geographic locations;
a client module for accepting client data including geographic location information for client devices;
a mobile target module for accepting mobile center data including geographic location information for mobile center units; and,
a geofencing module accepting client device geographic location information and mobile center unit geographical location information, creating geofence boundaries on the map around the mobile center unit geographic locations, and cross-referencing client device geographic locations to mobile center unit geofence boundaries.

2. The system of claim 1 wherein the communications subsystem has a first interface for accepting the client data from a geofencing service external to the system and a second interface for accepting the mobile center data from mobile center units.

3. The system of claim 1 wherein the communications subsystem has an interface for accepting the client data and the mobile center data from mobile center units.

4. The system of claim 1 wherein the client data includes client device geographic locations cross-referenced to time;
wherein the mobile center data includes mobile center unit geographic location cross-referenced to time; and,
whereon the geofencing module cross-references client device geographic locations to mobile center unit geofence boundaries with respect to the time.

5. The system of claim 4 wherein the mobile center units further comprise a media projection subsystem, selectively enabled to project media messages.
wherein the mobile center data includes media message projection enablement times; and,
wherein the geofencing module cross-references client devices located with the geofence boundaries to media message projection enablement times.

6. The system of claim 5 wherein the mobile center data includes the identification of a projected message, selected from a plurality of messages, cross-referenced to time; and,
wherein the geofencing module cross-references client devices located with the geofence boundaries to the projection times of the identified projected messages.

7. The system of claim 5 wherein the mobile center data includes mobile center unit geographic locations cross-referenced to durations of time the mobile center units are stationary.

8. The system of claim 1 wherein the mobile center data includes mobile center unit type; and,
wherein the geofencing module creates geofence boundaries for a mobile center unit based upon mobile center unit type.

9. The system of claim 1 wherein the geofencing module creates geofence boundaries for a mobile center unit based upon mobile center unit local environment.

10. A system for mobile media geofencing, the system comprising:
a communications subsystem having an interface to accept mobile media data including mobile media unit geographic location and mobile media unit media message projection information;
a map module comprising a map of predetermined geographic locations;
a mobile target module for accepting mobile media data including geographic location information for mobile media units, and positioning mobile media units on the map; and,
a geofencing module creating geofence boundaries on the map around the mobile media unit geographic locations, and cross-referencing the geofence boundaries to the media projection information.

11. The system of claim 10 wherein the mobile media data includes mobile media unit geographic location cross-referenced to time; and,
whereon the geofencing module cross-references mobile media unit geofence boundaries to media projection information with respect to the time.

12. The system of claim 11 wherein the mobile media data includes the identification of a projected message, selected from a plurality of messages, cross-referenced to time; and,
wherein the geofencing module cross-references the projected times of the identified messages to mobile media unit geofence boundaries.

13. The system of claim 11 wherein the mobile media data includes mobile media unit geographic locations cross-referenced to durations of time the mobile media units are stationary.

14. The system of claim 10 wherein the mobile media data includes mobile media unit type; and,
wherein the geofencing module creates geofence boundaries for a mobile media unit based upon mobile media unit type.

15. The system of claim 10 wherein the geofencing module creates geofence boundaries for a mobile media unit based upon mobile media unit local environment.

16. The system of claim 10 wherein the communications subsystem accepts client device data including client geographic location information;
the system further comprising:
a client module for accepting client data including geographic location information for client devices, and positioning the client devices on the map; and,
wherein the geofencing module cross-references client device geographic locations to mobile media unit geofence boundaries.

17. The system of claim 16 wherein the communications subsystem accepts client device geographic locations cross-referenced to time; and,
wherein the geofencing module cross-references client device geographic locations to mobile media unit geofence boundaries with respect to the time.

18. A system for aerial mobile center geofencing, the system comprising:
an aircraft comprising:
a location subsystem to determine aircraft geographic location;
a communication subsystem to receive instructions and transmit geographic location information;
a controller node comprising:
a communications subsystem to send instructions to the aircraft, receive geographic location information from the aircraft, and to rely the aircraft geographic location information to an analysis node;
the analysis node comprising:
a communications subsystem for receiving the relayed aircraft geographic location information;
a map module comprising a map of geographic locations;
a mobile target module for accepting aircraft geographic location information and positioning the aircraft on the map; and,
a geofencing module creating geofence boundaries on the map around the aircraft geographic location.

19. The system of claim 18 wherein the aircraft further comprises a media projection subsystem.

20. The system of claim 19 wherein the analysis node communications subsystem accepts client device geographic location information; and,
wherein the geofencing module cross-references client device geographic locations to the geofence boundaries.
